(19) United States
(12) Patent Application Publication
(10) Pub. No.: US 2025/0158722 A1
(43) Pub. Date: May 15, 2025

(54) METHOD FOR TRANSMITTING INFORMATION BY ENTANGLED QUANTA AND ASSEMBLY FOR CARRYING THE METHOD

(71) Applicant: Gerold WALLNER, Gumpoldskirchen (AT)

(72) Inventor: Gerold WALLNER, Gumpoldskirchen (AT)

(21) Appl. No.: 18/571,378

(22) PCT Filed: Jun. 21, 2022
(86) PCT No.: PCT/AT2022/060209

§ 371 Date: Jul. 24, 2024

(30) Foreign Application Priority Data
Jun. 21, 2021 (AT) A50503/2021

(51) Int. Cl. H04B 10/70; G02F 1/01; G02F 1/21

(52) U.S. Cl. CPC H04B 10/70; G02F 1/0136; G02F 1/212

(57) ABSTRACT

A method for information transmission using quanta that are entangled with signal quanta uses an arrangement providing for at least one spatial superposition within the system space paths, a temporal superposition of quantum operations that cancels the definitive assignment of information about the paths of the spatial superposition within the relativistic causality space, a superposition of a measurable and controllable attribute of the entangled quanta, and a manipulation method of this attribute and its phase solution space of the path integrals of the system of entangled quanta in the idler subsystem. It also changes the attribute in the idler subsystem and measures the resulting changing interference in a signal subsystem. In addition in the idler subsystem only the spatial overlay of exit modes without interference measurement is provided and in the signal subsystem the interference of the two exit modes is determined without using a coincidence measurement.

### TECHNICAL FIELD

This invention relates to a method for information transmission using entangled quanta capable of interference, specifically through idler quanta, which are entangled with signal quanta. It also concerns an arrangement for implementing the method.

The terms ‘idler’ and ‘signal’ are arbitrary; there is no rule dictating which of the quanta should be designated as ‘idler quanta’ and which as ‘signal quanta.’ Of two entangled quanta, one is designated as the ‘idler’ and the other as the ‘signal.’ If they are photons of different frequencies, for example, the photons of lower frequency can be designated as ‘idler’ and those of higher frequency as ‘signal,’ or vice versa.”

### STATE OF THE ART

### Entanglement

Known is the SPDC (spontaneous parametric down-conversion) process for generating entangled photons. When a photon is transmitted through a nonlinear medium (usually a nonlinear crystal), there's a probability that this photon is absorbed and simultaneously two new photons, a signal photon and an idler photon, are emitted. These photons are uniquely connected, forming a system of entangled photons. Due to entanglement, certain properties must always be considered in the context of a common system. Depending on the type of SPDC process, for example, the polarization of the individual photons generated in the SPDC process is correlated. This correlation applies to all properties subject to energy and momentum conservation (wavelength, momentum, spin, location, time, etc.). The property, e.g., polarization, can subsequently be altered locally in experiments or applications. If there is a correlation between the property and the optical path of the photon, knowledge about the path can be controlled via this property. Due to the simple manipulation possibilities of polarization through optical devices, polarization is one of the most commonly used properties of photons for controlling a setup.

It is particularly important that the phase space of entangled photons is inseparably common for the involved entangled photons from this point in time. This common phase space is the basis for visualizing the non-locality of entanglement through interference (see also EPR effect in Einstein [3]; EPR=Einstein-Podolsky-Rosen paradox). The common phase space is the common set of solutions for the respective phase states of all entangled quanta to fulfill the “principle of least action” of the entangled system.

Typically, a setup is divided according to the naming of the newly created photons into a signal and an idler subsystem. The term “pump beam” is also common for the sum of photons irradiating the nonlinear medium. After the nonlinear crystal, the pump beam weakened by the SPDC process, as well as the signal and idler beams, are differentiated.

### Spatial Superposition

Known is the fact that the measurement of interference is used to represent a state of a quantum system, usually in the form of an experiment or a technical setup. Also known are the requirements for photon interference. One of these requirements was described in Feynman's Lectures [4] as “alternative ways.” Another term is “spatial superposition,” which should express the “simultaneous” use of different paths or the ignorance of the path when there are several equivalent path variants. A spatial superposition is the connection of two points in spacetime through several equivalent paths or path combinations. The minimum number of equivalent paths for a spatial superposition is two.

If such path variants are overlaid again, for example, using a beam splitter, interference can be measured. If it is fundamentally possible to determine the path of the photon, the spatial superposition is reduced to one path within the set of variants. As a result, there is only one fixed path in the specific case and therefore no interference.

A fundamental description of this fact is the concept of Feynman's path integral (Feynman [5]).

In entangled systems, a local spatial superposition also affects all entangled partner photons.

### Temporal Superposition-Causal Superposition

For the non-locality of an EPR effect, it is necessary that even from a relativistic perspective, a defined temporal order between quantum operations applied separately to the individual partners of the entangled system and influencing the visibility of interference cannot be determined in a “space-like” arrangement of the relevant quantum operations. This can also be understood as an analogy to spatial superposition (spatial dimensions of spacetime) in the dimension of time. As long as a strict causal order cannot be determined, there is the potential for non-local manipulation of the common phase space of the entangled photons, thus also in space-like separation.

Numerous experiments have proven the non-local nature of the EPR effect. Particular emphasis was placed on demonstrating the instantaneous correlation in space-like separation (space-like setup) of the involved entangled photons (e.g., Ma [6]). Depending on the relativistic reference frame, experiments are conducted under the term “delayed choice” or “late choice,” thus expressing the temporal superposition of the involved quantum operations. Another common, although discussed differently, term for such a quantum operation is “quantum eraser.” Such operations can maintain a spatial superposition or reduce the quanta to a determinable path. This is associated with the fulfillment or non-fulfillment of the precondition of interference and its measurement.

### Shared Phase Solution Space of Entangled Quanta

Based on Fermat, Lagrange, Hamilton, and Dirac, Feynman's path integral concept (Feynman [5]) also relies on the “principle of least action”. This principle applies to a photon and a determinable path (path: connection from starting point to endpoint) as well as to a photon and a spatial superposition of at least two paths. It gets more complicated with entangled photons. Here, the paths of each entangled partner form a common solution space for the phases of the path integrals of the individual entangled partners. That is, the phase of the entangled partner photon plays an equally important role in local interferences. The apparently locally occurring interference in entangled photons is thus a non-locally influenced interference (second-order interference). Particularly significant are those experiments that establish indistinguishability in the idler subsystem only by overlaying paths without measuring interference in this subsystem (Zou [1]; Galvez [7]; Lemos [2]). This avoids an additional phase group, for example, caused by a beam splitter for superimposing and interference measurement. This phase group, which is shifted by π/2 due to the properties of a beam splitter, would only make interference measurement of the signal subsystem possible through coincidence measurement with the idler subsystem (Jaeger [8]).

In Lemos et al., FIG. 4 summarizes the introduction of a phase π in the idler subsystem (silicon cat) and its consequence in the signal subsystem.

The reference list at the end of this description contains implemented experiments related to this invention.

Two examples are particularly suitable for the already proven non-local influence of interference. In Galvez [7], the fundamental possibility is expressed, among other things, in the sentence: [ . . . . Here we demonstrate the possibility of using quantum mechanics to change the phase of the interference “remotely,” i.e., via manipulations on quantum-correlated photons that are in a remote location]. This experiment was not developed with communication in mind. The experimental setup was chosen such that coincidence measurement for selecting subsets of the entangled photon pairs was an essential part. However, Equation (2) of this work shows the shared phase solution space of entangled quanta in the context of the path integral.

The second example, Lemos [2], was also not designed for communication purposes. The arrangement cannot derive a real advantage from the non-local effect. Nevertheless, the impact of a phase change in the idler subsystem on the interference measurement in the signal subsystem is impressively demonstrated in FIG. 4. In this experiment, the measurement of interference in an interferometer (in this case, a Mach-Zehnder interferometer) solely by signal photons and without the aid of coincidence measurement is the crucial point.

Numerous experiments exist for the proof of non-locality and “delayed choice” (also for the arrangement variant “late choice”). Ma [9] provides a wonderful overview.

### PRESENTATION OF THE INVENTION

The objective of the present invention is to improve the speed of signal transmission, especially in the fields of communication and time-critical information processing, using a temporal superposition (causal superposition) of quantum operations, even in relativistic scenarios and within relativistic causality.

This task is solved by a method of the aforementioned type by using an arrangement that:
a) provides for at least one spatial superposition within the system space “paths”;
b) provides for a temporal superposition of quantum operations (quantum eraser), which cancels the definitive assignment of information about the paths of the spatial superposition within the relativistic causality space;
c) provides for a superposition (carrier superposition) of a measurable and controllable attribute of the entangled quanta, e.g., their polarization;
d) provides for a manipulation method of this attribute and its phase solution space of the path integrals of the system of entangled quanta, specifically in the idler subsystem;
e) provides in the signal subsystem two exit modes for measuring interference and in the idler subsystem only the spatial superimposition of exit modes without interference measurement, and that with the manipulation method in the idler subsystem, the attribute is changed and the resulting changing interference in the signal subsystem is measured.

One of the “quantum erasers” can be realized by an interferometer in the signal subsystem, which represents the combined state of the entangled system of quanta through “second order interference.”

Depending on spatial conditions, the latency time in the method according to the invention can even be negative.

The core of the invention is the correlatability of the aforementioned attribute (which is also entangled) with the phase solution space of the path integrals of the system of entangled quanta, where the attribute is controlled using a manipulation method.

In the following, photons serve as representatives of quanta, although the invention can in principle be realized with both bosons and fermions, e.g., also with electrons. The preferred attribute is polarization.

In this case, an arrangement for implementing the method may include:
a) a photon source, especially a laser;
b) a source of entangled photons, especially a nonlinear crystal, which generates entangled photons from the photons of the laser, namely signal photons and idler photons;
c) a beam guidance system that directs the signal photons into a signal subsystem and the idler photons into an idler subsystem;
d) in the signal subsystem:
i) an interferometer;
ii) at least one detector at the output of the interferometer;
e) in the idler subsystem:
iii) a Mach-Zehnder aligner with two polarizing beam splitters, where a half-wave plate is located in both arms and a mirror is movable; or a Pancharatnam-Berry phase shifter; and
iv) after the Mach-Zehnder aligner or the Pancharatnam-Berry phase shifter, a polarizer for erasing the path information in the idler subsystem.

The interferometer is preferably a Mach-Zehnder interferometer, in which the first beam splitter is a polarizing beam splitter and in which an optical element that rotates the plane of polarization by 90°, especially a half-wave plate, is arranged in one of the two arms of the interferometer. In such an interferometer, interference occurs with a linearly polarized incoming beam of light that is inclined 45° to the polarization direction of the polarizing beam splitter, as in this case, the horizontal component and the vertical component are in phase. With proper adjustment of the overall system, all photons reach detector Det-2. However, if the two components are phase-shifted by 180° (e.g., with a Pancharatnam-Berry phase shifter), a linearly polarized beam of light occurs again, but with a phase shift of 180°, which again represents one of the two states of the interferometer with maximum contrast. Surprisingly, it was found within the scope of the present invention that it does not matter whether the phase shift is made in the signal branch or the idler branch.

The method can also be applied in a “space-like” arrangement. The present invention enables the optimization of signal transmission speed and realizes causality in relativistic space-time systems by switching between two measurable states.

Since in quantum mechanics, measurement results appear in probabilities, the measurement of interference is also a statistical method.

### BRIEF DESCRIPTION OF THE DRAWINGS

FIG. 1 depicts the overall system with all its stages;

FIG. 2 is an example arrangement of such an overall system; and

FIG. 3 is another example arrangement of such an overall system.

### WAYS TO IMPLEMENT THE INVENTION

### Basic Principle of the Invention

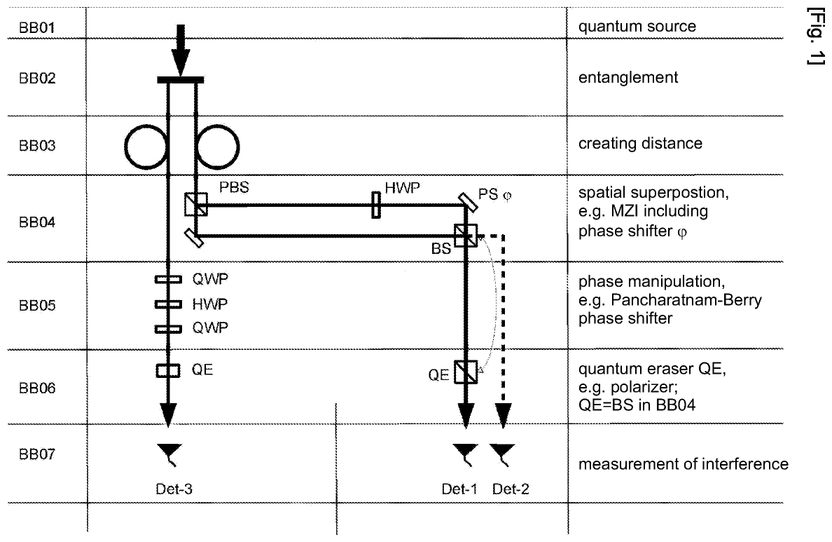

To enable the possibility of interference measurement with non-local influence, the following building blocks (hereafter referred to as BB, see FIG. 1) are required. According to the state of the art, the order of some elements of the arrangement, with which the photons interact, can be interchanged without fundamentally changing the process or the end state.

### BB01) Quantum Source (Source)

Depending on the desired target type of an entangled quantum system, the quantum source is to be selected. The method is suitable for both fermions and bosons. The following describes the process using photons (bosons).

Typically, a laser serves as the source of the pump beam, for example, linearly polarized. Depending on the target implementation, intensity and wavelength can be freely chosen. Also, depending on the field of application, a choice can be made between pulsed and continuous lasers.

### BB02) Entanglement (Entanglement of Quanta)

Using a suitable method, such as SPDC (spontaneous parametric down-conversion), pairs of entangled photons are generated.

To have full control over the status of the path information, the property of polarization is particularly suitable. For example, by using a nonlinear medium, which is arranged in two layers with their optical axes rotated by 90° to each other, a superposition of the polarization of [Math. 1]

1/√2 (HH+VV).

can be established (Kwiat 1999 [10]). Such a superposition is suitable for the targeted application of phases and is therefore used as a “carrier superposition.” The optimization of the phase relationship within the superposition can be achieved, for example, by wavelength-suitable, birefringent compensation delay plates (HWP). This type of optimization is not further elaborated here. (Pysher [11])
BB03) Construction of Distance and/or Inequality of Optical Path Length (Propagating Quanta)

To maximize the benefit from the non-local effect, large distances between the subsystems and the use of photons, for example for information transmission, are particularly useful. Depending on the application goal, the inequality of the two lengths of the optical path can be utilized. To exploit the effect of a “delayed choice,” a length ratio of

VD in the idler subsystem>>VD in the signal subsystem

is required.

In miniaturized applications for information processing, the inequality of lengths with simultaneously small distances is important.

The type of transmission has no fundamental impact as long as the preservation of defined properties is ensured. For example, if polarization is used as a carrier superposition, then the transmission method of the photons must ensure the controllability of the polarization state (e.g., polarization stabilizers).

### BB04) Establishment of a Spatial Superposition (Spatial Superposition)

To measure interference, a spatial superposition is required. A particularly suitable arrangement for establishing a spatial superposition is a Mach-Zehnder interferometer (MZI). To have full control over the status of “knowledge of which path” and also full control over the phase solution space of the path integrals, the use of a polarizing beam splitter (PBS) as the first beam splitter of the interferometer is recommended.

The spatial superposition established by the MZI and its local phase solution space are also co-determined by the phases of the idler photons through entanglement.

Since maintaining the spatial superposition requires indistinguishability of the paths taken by the signal photons through the interferometer, the polarization must be changed in one arm of the interferometer, for example, by a delay plate HWP 45°. This gives the second beam splitter (BS) the function of a “quantum eraser.” By superimposing in the second beam splitter, the traceability of the path through the interferometer is prevented, and interference becomes measurable. The “quantum eraser” operation initially only refers to the signal subsystem but is also dependent on maintaining indistinguishability in the idler subsystem.

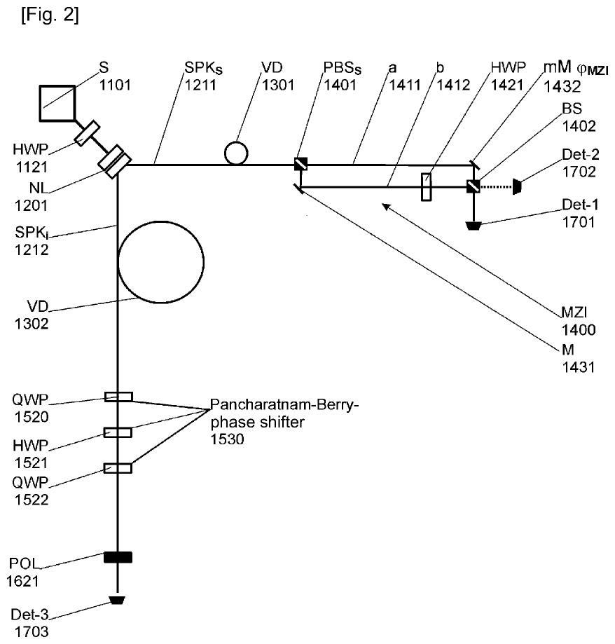

To achieve higher significance of detections in detector Det-1, the phase solution space of the interferometer must be chosen through appropriate measures (e.g., phase shifters in the form of the movable mirror PSP in FIG. 1 or the movable mirror mMφ MZI in FIG. 2) so that the maximum intensity is found in the output mode towards detector Det-2. Thus, only those photons are directed towards detector Det-1 that have been imprinted with an additional phase difference (optimally x) in the idler subsystem.

### BB05) Imprinting a Phase Difference on the Carrier Superposition (Manipulate the Phase State)

To influence the entangled phase solution space, targeted manipulation of the phases within the carrier superposition is required.

This can be achieved, for example, by a Pancharatnam-Berry phase shifter (Kwiat1991 [12]), consisting of two quarter-wave plates QWP, between which a half-wave plate HWP is arranged, or a pMZA (polarizing Mach-Zehnder aligner) with integrated phase difference control. With a Pancharatnam-Berry phase shifter, the phase relationship [Math.]

$$1 / √ 2 ( {H}_{s} {H}_{i} + {e}^{i φ} {V}_{s} {V}_{i} )$$

can be generated from the carrier superposition [Math.]

$$1 / √ 2 ( {H}_{s} {H}_{i} + {V}_{s} {V}_{i} ) ,$$

where φ results from the additional rotation angle β of the Pancharatnam-Berry phase shifter in the relationship φ=4β (Galvez [7]). By changing the phase relationship within the carrier superposition, the entire phase solution space of the entangled partners is also changed, thus influencing the statistical probability of the intensities of the output modes towards detectors Det-1 and Det-2.

### BB06a) “Quantum Eraser” in the Signal Subsystem

To ensure the indistinguishability of paths within the spatial superposition, a “quantum eraser” operation is required. This operation can, for example, be fulfilled by the second beam splitter in the MZI. However, the indistinguishability of the paths also depends on the idler subsystem.

### BB06b) “Quantum Eraser” in the Idler Subsystem

In the idler subsystem, after imprinting the phase difference within the carrier superposition, a “quantum eraser” QE operation is required (HWP-22.5, polarizer, absorption). This can be realized, for example, by a polarizer. (Walborn [13])

The method also allows influencing the interference in the MZI of the signal subsystem by measuring the polarization of the idler photon and the path of the entangled signal photon in the MZI determined thereby, by rotating the polarizer into a suitable plane of polarization that reveals the path information. This inhibits the interference. The intensities are then equal in both output modes of the MZI in the signal subsystem for 50:50 beam splitters.

### BB07) Measurement of the Interference (Measurement of the Existence of Interference)

By measurements of detectors Det-1 and Det-2, the existence of interference can be locally determined, and, if implemented, the correlation between the imprinted phase difference in the idler subsystem and the intensity maxima of the output modes of the MZI in the signal subsystem shows the state of the manipulation mechanism of the shared phase solution space, which can also be determined at a statistical level.

### Description of Two Preferred Embodiments

The non-locality of EPR effects in entangled quanta is a well-established state of science and technology. The representation of the common phase state of an entangled pair of photons with only one partner is known (Ma [6]; Lemos [2]). The present invention allows for the local measurement of non-local influence in entangled photons. The use of a coincidence measurement is not required.

The “quantum eraser” operators, as the respective concluding operation of the respective partners of the entangled photon pair in the two subsystems to maintain the spatial superposition, establish a temporal superposition of the temporal sequence:
(QE s temporally before QE i)+(QE s temporally after QE i)
   thus creating the basis for an EPR effect and thus also for a “delayed choice” effect.

In the following, not only four-digit reference signs but also short names are used for readability, referring to the implementation example in FIG. 2. The second digit of the reference signs codes the stage of the model (Building Block) from FIG. 1. The last two digits are unique numbers within the respective building block.

All optical and electronic measures to increase the significant photon rate in the detector, such as optical lenses, filters, coatings of optical elements, wavelength-dependent optimization of optical elements, compensators to balance the path lengths in the MZI and the pMZA, etc., are not explicitly shown.

The process requires a source of entangled photons.

A typical source for photons is a collinear, monochromatic laser, as shown in FIG. 2 by S 1101. The wavelength can be 405 nm. The quality of the polarization can be improved by a polarizing beam splitter that deflects photons with undesirable polarization from the pump beam (laser diode polarization ratio). Thus, the pump beam has only one polarization, for example, horizontal.

To generate the desired carrier superposition, the pump beam is rotated using an HWP 22.5° 1121 to a superposition of polarization [Math.]

$$1 / √ 2 ( {H}_{p} + {V}_{p} )$$

(the index p stands for “pump beam”).

A pair of BBO crystals NL 1201, rotated by 90° to each other, are used to generate entangled photons. The orientation of the composite BBO crystals is chosen so that a 3° cone of entangled photons (signal photons and idler photons) with an identical wavelength of 810 nm is created through the SPDC process. In a Type I SPDC process with the described composite crystals and the described pump beam, entangled photon pairs are formed in the carrier superposition [Math.]

$$1 / √ 2 ( {H}_{s} {H}_{i} + {V}_{s} {V}_{i} )$$

(Kwiat 1999 [10], the indices s and i stand for signal and idler). The part of the pump beam that is not converted is absorbed by a beam dump after the BBO crystals NL 1201 (not shown).

The entangled photons are directed into different subsystems, the signal subsystem mode |SPK s>1211 and the idler subsystem mode |SPK i>1212. For better controllability of the photons and the paths they traverse, a source of linearly polarized photons transformed into one of the Bell states, here [Math.]

$$Φ + ( 1 / √ 2 ( {H}_{s} {H}_{i} + {V}_{s} {V}_{i} ) ) ,$$

is chosen.

The photons can be transmitted in free transmission or in light conductors (fiber). When using light conductors, polarization stabilizers are required if the carrier superposition for phase manipulation is the polarization.

### Signal Subsystem

The arbitrary and therefore variable length of the optical path from the source of the entangled photons NL 1201 to the beam splitter is expressed by the circle with the label VD 1301 (VD=variable distance).

For the method, at least a spatial superposition of paths as part of the overall system is required. This spatial superposition is created by an interferometer, in this embodiment by a Mach-Zehnder interferometer MZI 1400. Since local measurement in the signal subsystem is intended, the interferometer is arranged in the signal subsystem. Since entangled photons jointly define the phase solution space of the path integrals, the existence of a spatial superposition in one of the subsystems is sufficient.

By using a polarizing beam splitter PBS s 1401 in the interferometer in the signal subsystem in the implementation example, the path specification for the polarization superposition is each clearly defined: the two modes of the spatial superposition a 1411 and b 1412 are created. Mode b is deflected by a fixed mirror M 1431, mode a by an adjustable mirror mMφ MZI 1432, so that both meet on a beam splitter BS 1402. This is a 50:50 beam splitter and overlays the two modes of the spatial superposition a 1411 and b 1412. Since in the path of mode b 1412, an HWP 45° 1421 (HWP=half-wave plate) is arranged so that the polarization of the photons in this arm of the interferometer is changed to the other polarization, the overlaid photons become indistinguishable in the passage through the beam splitter and can therefore interfere.

The beam splitter BS 1402 fulfills the task of the “quantum eraser” operation at the end of the spatial superposition. After that, in the signal subsystem, it is ensured that the path sequence cannot be traced from the information of the signal subsystem.

According to the common phase and the resulting probability distribution, the signal photon is directed either towards detector Det-2 1702 or detector Det-1 1701.

To optimize the MZI, the mirror mMφ MZI 1432 is linearly movable and arranged as a phase shifter. This type of phase control within an MZI can be found, for example, in Heuer [15]. This type of construction of an MZI can also be found, for example, in Cramer [16].

### Idler Subsystem

The optical distance between the source of the entangled photons and a Pancharatnam-Berry phase shifter 1530 can be implemented arbitrarily and therefore variably long. This is expressed by the circle with the label VD 1302. To implement a “delayed choice” arrangement, the length ratio

VD 1302>>VD 1301

is necessary.

The idler subsystem implements a device for introducing a phase difference into the “carrier superposition,” which here is the polarization. The variant according to FIG. 2 is realized by a Pancharatnam-Berry phase shifter 1530 as follows:

The Pancharatnam-Berry phase shifter 1530 consists of two quarter-wave plates QWP 1520, 1522, between which a half-wave plate HWP 1521 is arranged. In this way, the phase of the carrier superposition can be changed by a value B m by rotating the HWP 1521, which is part of the Pancharatnam-Berry phase shifter 1530, see Galvez [7].

The polarizer POL 45° 1621 has the task of making the polarization in the idler subsystem indistinguishable and thus also “erasing” the path information in the idler subsystem. This explicitly implements the operation “quantum eraser.” Together with the “quantum eraser” operation in the signal subsystem, this keeps the spatial superposition active, allowing the measurement of interference in the signal subsystem.

The measurement in detector Det-3 1703 is not necessary for signal recognition in the signal subsystem (statistical signal/protocol).

The non-local influence on the phase solution space of the MZI by imprinting an additional phase difference in the idler subsystem can be measured at the two output modes of the 50:50 beam splitter BS 1402 by detectors Det-1 and Det-2 as a statistical protocol. This measurement of “second order interference” is already measurable with one detector when the correct phases @ MZI and β m are chosen.

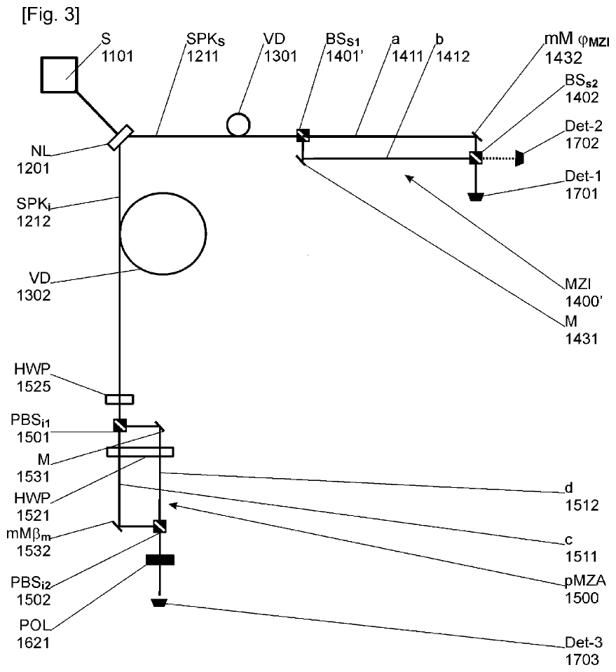

The embodiment according to FIG. 3 differs, among other things, in that instead of the Pancharatnam-Berry phase shifter 1530, a pMZA 1500 is provided: Two polarizing beam splitters PBSᵢ₁ 1501 and PBSᵢ₂ 1502 fulfill the task of superimposing two modes without, however, making interference measurable (“alignment” in Zou [1]), resulting in a pMZA 1500 (polarizing Mach-Zehnder aligner).

Before the pMZA 1500, there is an HWP 1525, which turns the polarization into the plane +45° (or −45°). Instead of an HWP, an EOM (electro-optical modulator) can naturally also be used to turn the polarization plane accordingly. The HWP 1525 creates a superposition of paths in the subsequent pMZA 1500.

Horizontally and vertically polarized photons are directed into each arm of the pMZA 1500 by the polarizing beam splitter PBSᵢ₁ 1501. In one arm, designated as mode d 1512, there is a fixed mirror M 1531, and in the other arm, designated as mode c 1511, there is an adjustable mirror mMβₘ 1532. Through these two mirrors, the photons in both arms are directed at the polarizing beam splitter PBSᵢ₂ 1502, where they are recombined.

The linearly movable mirror mMβₘ 1532 realizes a phase shifter with the phase βₘ, so that these photons can be imprinted with an additional phase βₘ (in an idealized realization, βₘ=π). This phase is precisely associated with a specific polarization by the pMZA 1500.

To enable the modes c 1511 and d 1512 in the polarizing beam splitter PBS i2 1502 to be overlaid without interference, the respective polarization is swapped by the HWP 1521 (which can also be implemented by two HWPs). For this, an HWP 45° 1521 is necessary in both modes to ensure the desired transmission/reflection in the beam splitter PBS i2 1502 (Jacques [14]).

Thus, this device resembles an interferometer, but since no interference is to be measured, it is not an interferometer in the strict sense. Therefore, this arrangement is referred to in this description as a polarizing Mach-Zehnder aligner (pMZA).

Through the phase shifter, an additional phase can be introduced, which then acts only for this part of the superposition of the polarization. Depending on the chosen polarization plane of PBSᵢ₁ 1501, [Math.]

$$1 / √ 2 ( {H}_{s} {H}_{i} + {V}_{s} {V}_{i} ) ,$$

becomes [Math.]

$$1 / √ 2 ( {H}_{s} {H}_{i} + {e}^{i β} {V}_{s} {V}_{i} )$$

### or [Math.]

$$1 / √ 2 ( {e}^{i β} {H}_{s} {H}_{i} + {V}_{s} {V}_{i} )$$

Without limiting generality, the position of the mirror mMβₘ 1532 can be chosen so that in the case of interference in the signal subsystem, the maximum intensity occurs at detector Det-2.

Another difference in the embodiment according to FIG. 3 is that in the MZI 1400′, instead of the polarizing beam splitter PBS s 1401, a regular beam splitter BSₛ₁ 1401′ is provided. (For systematic reasons, the beam splitter BS 1402 from FIG. 2 is labeled as BSₛ₂ 1402 in FIG. 3.) This eliminates the need for the HWP 1421. Another simplification is in the generation of the entangled particles: here, the photons from the laser S 1101 fall directly onto a nonlinear crystal NL 1201.

The detection of interferences can only be achieved through statistical protocols, as the detection of a single quantum within the interferometers, e.g., in detector Det-1 1701, has no informative value (e.g., dark count rates of the detectors). The local measurement of the consistency of detections by detectors Det-1 1701 with Det-2 1702 can be used to improve the quality of the measurement.

In addition to optimizing the efficiency of each stage, the massive parallel use of such communication channels is a valid method for improving baud rates by magnitudes of 2 to 4 or even more and enables time-efficient error correction.

An additional improvement can be achieved by implementing such communication channels also in the opposite direction to confirm the transmitted information. In this case, relativistic causality “causal coherence” must be respected.
[1] X. Y. Zou, L. J. Wang, and L. Mandel, “Induced coherence and indistinguishability in optical interference”, Phys. Rev. Lett., vol. 67, no. 3, pp. 318-321, July 1991, doi: 10.1103/PhysRevLett.67.318.
[2] G. B. Lemos, V. Borish, G. D. Cole, S. Ramelow, R. Lapkiewicz, and A. Zeilinger, “Quantum imaging with undetected photons”, Nature, vol. 512, p. 409, August 2014.
[3] A. Einstein, B. Podolsky, and N. Rosen, “Can Quantum-Mechanical Description of Physical Reality Be Considered Complete?”, Phys. Rev., vol. 47, no. 10, pp. 777-780, May 1935, doi: 10.1103/PhysRev.47.777.
[4] “The Feynman Lectures on Physics Vol. III Ch. 1: Quantum Behavior”, https://www.feynmanlectures.caltech.edu/III_01.html#Ch1-S7 (accessed Sep. 19, 2020).
[5] R. P. F. PH.D, R. P. Feynman, A. R. Hibbs, and A. R. Hibbs, “Quantum Mechanics and Path Integrals”, McGraw-Hill, 1965.
[6] X. Ma et al., “Quantum erasure with causally disconnected choice”, Proc Natl Acad Sci USA, vol. 110, no. 4, pp. 1221-1226 January 2013, doi: 10.1073/pnas. 1213201110.
[7] E. J. Galvez, M. Malik, and B. C. Melius, “Phase shifting of an interferometer using nonlocal quantum-state correlations”, Phys. Rev. A, vol. 75, no. 2, p. 020302, February 2007, doi: 10.1103/PhysRevA.75.020302.
[8] G. Jaeger, M. A. Horne, and A. Shimony, “Complementarity of one-particle and two-particle interference”, Phys. Rev. A, vol. 48, no. 2, pp. 1023-127 August 1993, doi: 10.1103/PhysRevA.48.1023.
[9] X. Ma, J. Kofler, and A. Zeilinger, “Delayed-choice gedanken experiments and their realizations”, Rev. Mod. Phys., vol. 88, no. 1, p. 015005, March 2016, doi: 10.1103/RevModPhys.88.015005.
[10] P. G. Kwiat, E. Waks, A. G. White, I. Appelbaum, and P. H. Eberhard, “Ultra-bright source of polarization-entangled photons,” Phys. Rev. A, vol. 60, no. 2, pp. R773-R776, August 1999, doi: 10.1103/PhysRevA.60.R773.
[11] M. J. Pysher, E. J. Galvez, K. Misra, K. R. Wilson, B. C. Melius, and M. Malik, “Nonlocal labeling of paths in a single-photon interferometer,” Phys. Rev. A, vol. 72, no. 5, p. 052327, November 2005, doi: 10.1103/PhysRevA.72.052327.
[12] P. Kwiat, “Observation of a nonclassical Berry's phase for the photon”, ResearchGate https://www.researchgate.net/publication/13245896_Observation_of_a_nonclassical_Berry's_phase_for_the_photon, March 1991 (accessed Sep. 6, 2020).
[13] S. P. Walborn, M. O. T. Cunha, S. Padua, and C. H. Monken, “A double-slit quantum eraser,” Phys. Rev. A, vol. 65, no. 3, p. 033818, February 2002, doi: 10.1103/PhysRevA.65.033818.
[14] V. Jacques et al., “Experimental realization of Wheeler's delayed-choice Gedanken Experiment” in 2007 European Conference on Lasers and Electro-Optics and the International Quantum Electronics Conference, June 2007, pp. 1-1, doi: 10.1109/CLEOE-IQEC.2007.4386903.
[15] A. Heuer, R. Menzel, and P. W. Milonni, “Induced Coherence, Vacuum Fields, and Complementarity in Biphoton Generation”, Phys. Rev. Lett., vol. 114, no. 5, p. 053601, February 2015, doi: 10.1103/PhysRevLett.114.053601.
[16] J. G. Cramer and N. Herbert, “An Inquiry into the Possibility of Nonlocal Quantum Communication,” arXiv: 1409.5098 [quant-ph], September 2014, Accessed: Feb. 19, 2019. [Online Available: http://arxiv.org/abs/1409.5098].

1-4. (canceled)

5. In a method for information transmission using idler quanta that are entangled with signal quanta and using an arrangement that:
a) provides for at least one spatial superposition within the system space paths;
b) provides for a temporal superposition of quantum operations that cancels the definitive assignment of information about the paths of the spatial superposition within the relativistic causality space;
c) provides for a superposition of a measurable and controllable attribute of the entangled quanta;
d) provides for a manipulation method of this attribute and its phase solution space of the path integrals of the system of entangled quanta in an idler subsystem; and
e) with the manipulation method, changes the attribute in the idler subsystem and measures the resulting changing interference in a signal subsystem,
the improvement wherein in the idler subsystem only the spatial overlay of exit modes without interference measurement is provided and that in the signal subsystem the interference of the two exit modes is determined without using a coincidence measurement.

6. An arrangement for carrying out the method according to claim 5, comprising:
a) a photon source,
b) a source of entangled photons that generates from the photons of the source entangled signal photons and idler photons;
c) a beam-guidance system that directs the signal photons into a signal subsystem and the idler photons into an idler subsystem;
d) in the signal subsystem:
i) an interferometer;
ii) at least one detector at the output of the interferometer;
e) in the idler subsystem:
iii) a Mach-Zehnder aligner with two arms, two polarizing-beam splittersm and a half-wave plate in each both arm, one of the mirrors being movable; or a Pancharatnam-Berry phase shifter; and
iv) after the Mach-Zehnder aligner or the Pancharatnam-Berry phase shifter, a polarizer for erasing the path information in the idler subsystem.

7. The arrangement according to claim 6, wherein the interferometer mentioned in i) is a Mach-Zehnder interferometer having two arms, two beam splitters, and a mirror in each arm.

8. The arrangement according to claim 7, wherein one of the beam splitters of the Mach-Zehnder interferometer is a polarizing-beam splitter and an optical element that rotates the plane of polarization by 90° is arranged in one of the two arms of the interferometer.
